(19) United States
(12) Patent Application Publication
(10) Pub. No.: US 2003/0217264 A1
(43) Pub. Date: Nov. 20, 2003

(54) System and method for providing a secure environment during the use of electronic documents and data

(75) Inventors: Andrew K. Martin, Newton, MA (US); Bruno Tramontozzi, Newton, MA (US)

Correspondence Address: LAHIVE & COCKFIELD, 28 STATE STREET, BOSTON, MA, 02109, US

(73) Assignee: Signitas Corporation, Newton, MA (US)

(21) Appl. No.: 10/145,491

(22) Filed: May 14, 2002

(51) Int. Cl. H04L 9/00

(52) U.S. Cl. 713/156

(57) ABSTRACT

The illustrative embodiment of the present discloses a method of providing a secure environment during the use of electronic documents and data. Authenticated users are able to access, act upon and sign, via a secure connection, a workflow object that is stored on a remote server. The workflow object includes a sequence of action items, the steps in a workflow, and includes documents or references to documents required by the workflow. Also included in the workflow object is an Access Control List ( ACL ) which specifies which users can access which documents at which times. Each document has its own ACL which allows the access of each document to be specified independently from other documents at a given time. The documents may be encrypted and decrypted using a variety of methods designed to enhance security, including the use of digital signatures. Once a document is decrypted ( if encrypted), the user performs a task specified in the workflow using the decrypted document. The workflow is updated to reflect completed tasks, the document may be electronically signed, and the altered document is then re-encrypted.

### FIELD OF THE INVENTION

The illustrative embodiment of the present invention relates generally to the use of electronic documents and data and more particularly to the provision of a secure environment for the use of electronic documents and data being accessed and used over a network.

### BACKGROUND

Workflow is a term used to describe the sequence of operations necessary to complete a task. The sequence of operations constituting a workflow frequently involves the use or signature of documents. The concept of workflow has been extended to encompass the performance of operations which utilize electronic documents. For example, members of a development team may find it necessary to collaborate on the production of a report that each member of a team accesses individually from a remote location over a network. The collaboration may require that various members of the team access the document and perform specified operations in a particular sequence. A workflow with associated electronic documents (“electronic workflow”) may indicate the order in which various development team members should access the document to perform the operations specified in the workflow. Alternatively, a workflow may involve several documents, each of which has its own life cycle, and may require different people to access the different documents at different times in a particular order.

The use of electronic workflow raises important security issues. The security issues involve controlling access to the electronic documents associated with the workflow in order to ensure data integrity and authenticity. Conventional methods of allowing access to electronically stored documents either do not involve the use of an associated workflow, or fail to take adequate security precautions to ensure data integrity and authenticity. Electronic documents not associated with a workflow may be executed out of sequence or by the wrong parties while invalid data or forged documents prevent the proper execution of the workflow. Conventional methods that allow collaboration by team members on a single electronic document fail to satisfactorily verify an author of a document since they provide no mechanism to correlate changes in the document with particular team members. Additionally, a development team member accessing a collaborative document ordinarily has no way to verify that the document content has not been altered in the time period since a previous development team member worked on the document.

### BRIEF SUMMARY OF THE INVENTION

The illustrative embodiment of the present invention provides a method for providing a secure environment in which to execute workflow which uses electronic documents or data. Documents used in the workflow may or may not be encrypted prior to beginning the process required by the workflow. For example, transactional data is likely to be encrypted, while other types of data frequently are not encrypted. A number of means of encrypting the documents may be used, including the use of shared secrets (passwords) or asymmetric cryptography such as implemented in a Public Key Infrastructure, or PKI. Digital (and electronic) signatures are used as a means of signing a document in lieu of a handwritten signature. The binding of the signature with a secure hash of the document provides a means of validating the integrity of the data to ensure that no unauthorized actions have been taken. The workflow and any associated documents are decrypted and authenticated as necessary prior to use. Changes to the documents performed pursuant to the workflow are verified using security mechanisms, revision history and audit logs, and the workflow is updated. The revised document may be digitally signed if required by the workflow process. The updated document and the updated workflow may then be further encrypted to provide additional security. Subsequent authorized users accessing the electronic document first decrypt the document ( if it is encrypted ) and then verify the authenticity of the document. The method of the present invention thereby enables multiple users to remotely access an electronic document in order to execute an associated workflow while still addressing concerns regarding data security and validity. Security is provided using a system of Access Control Lists, a mechanism that provides fine-grained access control to objects by users by specifying exactly what types of access (e.g. view, write, delete) a given user is granted.

In one embodiment of the present invention, an electronic device is interfaced with a network. An encrypted document associated with a workflow is stored on the electronic device. The encrypted document is accessed from a remote location on the network. The user accessing the encrypted document decrypts the document and performs a task with the document that is specified by the workflow. Upon completion of the task specified in the workflow, the workflow is updated and the document is optionally re-encrypted and stored on the electronic device.

In another embodiment of the present invention, an electronic device holding an encrypted document and associated workflow is interfaced with a network and a location holding encryption information. The workflow and associated documents are accessed from a remote location on the network. The user accessing the workflow decrypts an associated document and verifies its authenticity by checking with the location holding encryption information. The user then performs a task using the document that is specified by the workflow. Upon completion of the task specified in the workflow, the workflow is updated and the user digitally signs the altered document using a private key and a hashing algorithm. The digitally signed hashed document is then further encrypted and stored on the electronic device.

In one embodiment, documents associated with a workflow are encrypted using a public key infrastructure (PKI). The workflow and associated documents are stored on a server interfaced with a network and a certificate authority. The certificate authority issues digital certificates binding user identities with public and private encryption keys utilized by the public key infrastructure. During an appropriate workflow action, a designated user signs the document utilizing their private key. The signed document is then returned to the repository along with the information necessary to retrieve the signer's public key for future verification. The system logs the details of each action taken upon the document for future audit. A user accessing a document uses the public key of the document signer to verify the signature on the document. After the user performs a task with the document specified in the workflow the document may be encrypted for additional security.

### BRIEF DESCRIPTION OF THE DRAWINGS

FIG. 1 is a block diagram of an environment suitable for practicing an illustrative embodiment of the present invention;

FIG. 2 is a block diagram of an alternative environment suitable for practicing an illustrative embodiment of the present invention;

FIG. 3 is a flowchart of the sequence of steps utilized by the illustrative embodiment of the present invention to securely execute workflow which uses electronic documents;

FIG. 4 is a flowchart of the sequence of steps utilized by the illustrative embodiment of the present invention to securely execute electronic document workflow through the use of a digital signature;

FIG. 5 is a flow chart of the sequence of steps followed by the illustrative embodiment of the present invention which uses a certificate authority in securely executing an electronic document workflow; and

FIG. 6 is a flowchart of the sequence of steps followed by the illustrative embodiment of the present invention while using an enTrust™ server.

### DETAILED DESCRIPTION OF THE INVENTION

The illustrative embodiment of the present invention provides a method of enhancing security in workflow which utilizes electronic documents. Authenticated users are able to access, act upon and sign, via a secure connection, a workflow object that is stored on a remote server. The workflow object includes a sequence of action items, the steps in a workflow, and includes documents or references to documents required by the workflow. Also included in the workflow object is an Access Control List ( ACL ) which specifies which users can access which documents at which times. Each document has its own ACL which allows the access of each document to be specified independently from other documents at a given time. The documents may be encrypted and decrypted using a variety of methods designed to enhance security, including the use of digital signatures. Once a document is decrypted ( if encrypted), the user performs a task specified in the workflow using the decrypted document. The workflow is updated to reflect completed tasks, the document may be electronically signed, and the altered document is then re-encrypted.

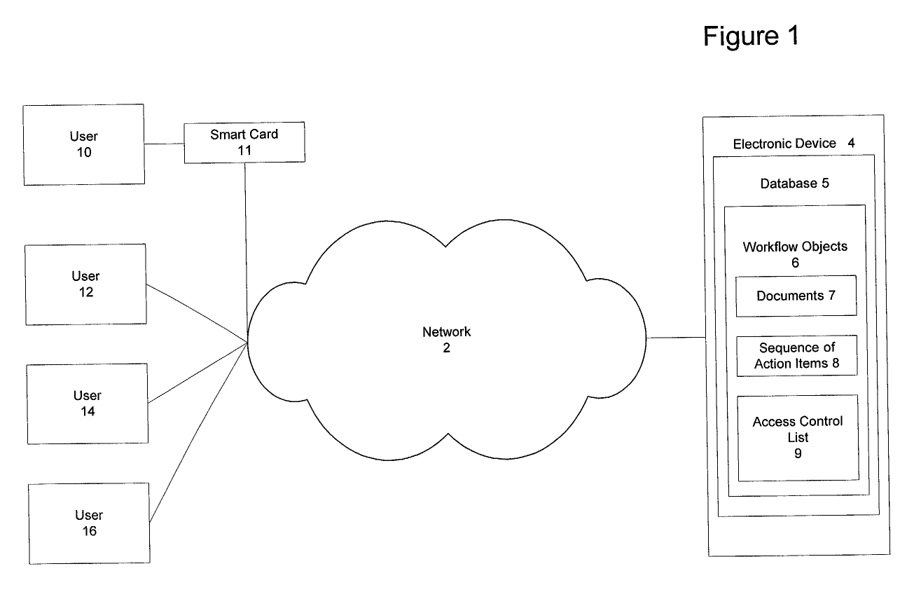

FIG. 1 depicts an environment suitable for practicing an illustrative embodiment of the present invention. An electronic device 4 is interfaced with a network 2. The network 2 may be the Internet, a wireless network, wide area network local area network, satellite network or some other type of network. The electronic device 4 may be a secure server in which all of the data stored on the server is held in encrypted form. Alternatively, the electronic device 4 may be another type of electronic device such as a web server, mail server, a networked client device , a PDA, etc. The electronic device 4 holds a database 5, such as an Oracle™ database. The database 5 includes multiple workflow objects 6. Each of the workflow objects 6 include documents 7 associated with a workflow, a sequence of action items 8 which are the actions required in the workflow, and an Access Control List ( ACL ) 9. The ACL is a data structure which is used to indicate which user can access a document 7 at a given time. The ACL 9 also includes a designation of a workflow coordinator. The workflow coordinator has access to all of the documents 7 and the ability to change document permission levels for other users. Those skilled in the art will recognize that the workflow objects 6 may contain references ( e.g.: pointers, names, IDs, etc. ) used to direct a user to the documents 7 required for the workflow instead of containing the entirety of the documents within the workflow object. Also interfaced with the network 2 are a plurality of users 10, 12, 14 and 16. The users access the database 5 over the network 2. The users 10, 12, 14, and 16 may make contact over the network 2 with the electronic device 4 using a secure connection such as a secure socket layers (S.S.L.) 3.0 connection. Once connected, the users 10, 12, 14 and 16 login to access the database 5. The login procedure may utilize a smart card 11 which is interfaced with the network 2 and holds encrypted security information used to validate the user. Alternatively, some other type of authentication procedure may be used. Once the identity of the users 10, 12, 14, and 16 is confirmed, a workflow object 6 controls access to the documents 7 based upon the current action item 8 required by the workflow. For example, if the second step of a workflow requires signatures from 3 users 10, 12 and 14, but not a fourth user 16, then the document 7 is decrypted and the ACL of the document is set granting access to the three required users, but not to the fourth user. Once the action item 8 has been completed by the users 10, 12 and 14, possibly requiring the application of an electronic signature, the sequence of action items 8 is updated, the altered document is reencrypted in the workflow object 6, and the workflow object 6 stored back in the database 5. Those skilled in the art will recognize that the workflow may or may not require encryption after the application of electronic signatures by the three users 10, 12 and 14.

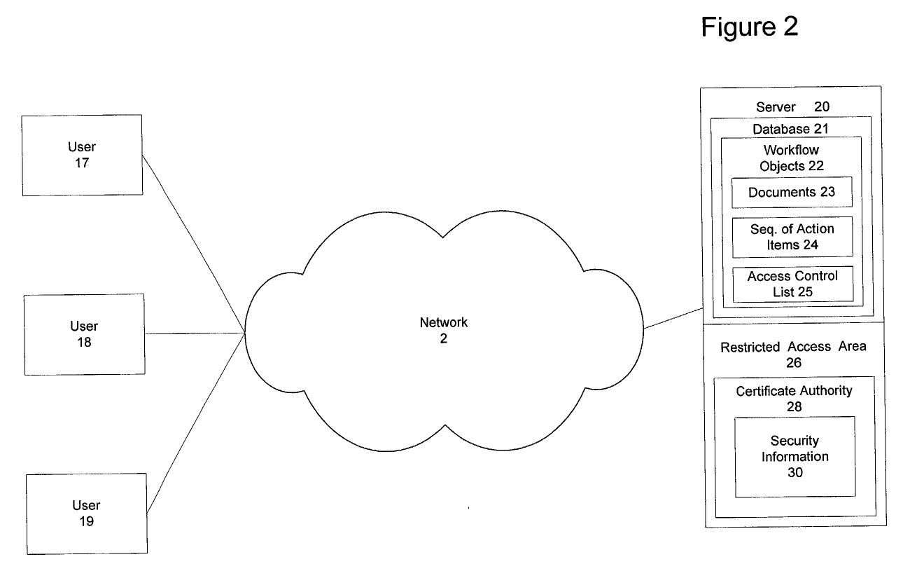

FIG. 2 depicts an alternate environment suitable for practicing the illustrative embodiment of the present invention. A plurality of users 17, 18, and 19 are interfaced with the network 2. Also interfaced with the network 2 is a server 20. The server 20 may be a secure server on which all stored data is encrypted. The server 20 holds a database 21. The database 21 stores multiple workflow objects 22. The workflow objects 22 include documents 23 with associated electronic signatures. Each electronic signature indicates the date of creation (signing date) of the related document 23 and the identity of the signer of the related document. Those skilled in the art will recognize that multiple means of digital signing are available in addition to the use of digital certificates by the illustrative embodiment of the present invention. Electronic signatures utilizing various methods of authentication, execution, and verification are valid. The system allows signing methods to be “plugged-in” as modules. The signing methods include PIN-authentication signature, electronic signature capture and digital signatures. A PIN-authentication signature uses a user defined access code. The access code is not limited to numeric data. When the user intends to sign, the user verifies its identity by providing the access code. The user has the ability to change or revoke an access code in order to maintain an appropriate level of security. A history of access codes is maintained on a secure server, such as an Oracle™ database in order to facilitate the verification of signed documents. In electronic signature capture, a user signs an electronic pad that captures an image of their signature and binds it to the document using hashing. The authentication and verification is based on the user's unique handwritten signature. For a digital signature, a user's private key from a digital certificate (or other cryptographic token such as smart card) is used to generate a unique signature of the document which is bound to the hash of the document. The signature is verified using the user's public key, which is available from the issuing Certificate Authority.

Other signature methods or token types may be integrated into the illustrative embodiment of the present invention. Those skilled in the art will recognize that the method of signing is not critical to the illustrative embodiment of the present invention, as long as the illustrative embodiment provides access control, authentication of the signer, and the ability to verify the signature and the contents of the document at the time of signing. Also included in the workflow object 22 are a sequence of action items 24 and an access control list 25 which controls access to the documents 23 based upon the current action item. The server 20 also includes a restricted access area 26 holding a certificate authority 28. The certificate authority 28 includes security information 30. Once the access control list 25 has been checked and the user 17 has gained access to the encrypted documents 23, the user may decrypt the documents using a public decryption key referenced in a certificate associated with the electronic document. Prior to relying upon the public key in the certificate to decrypt the document 23, the user 17 may verify a document's authenticity by confirming with the certificate authority 28 that the certificate is not listed as invalid by the security information 30. In an alternative embodiment, the restricted access area 26, certificate authority 28, and the security information 30 may be located remotely from the server 20 and accessible via a secure connection. In a different implementation, the document 23 stored in the workflow object 22 does not have an associated certificate and the users 17, 18 and 19 use a public encryption key that the creator of the encrypted document has previously provided. For security reasons, the public encryption key may be delivered to the user in a manner that does not utilize the network 2. In a different implementation, the document 23 stored in the workflow object 22 does not have an associated certificate and the documents are not encrypted. The users 17, 18 and 19 are granted access to the documents 23 based solely on the ACL 25.

A workflow represents a sequence of steps that is followed in order to accomplish a specific task. The illustrative embodiment of the present invention utilizes a workflow object 6 to facilitate the secure execution of workflow involving the use of electronic documents. The process of creating the workflow object 6 may utilize a template to form part or all of the workflow object. If the workflow is a commonly occurring one, such as for a commercial real estate transaction in which the same type of documents are always required to be signed, a template outlining the process may provide a framework for the workflow. Alternatively, if the workflow being created is for a relatively unique event, the workflow object can specify a unique sequence of action items, a customized ACL and a set of documents or document references chosen particularly for the workflow. The workflow may require a number of users to sequentially examine the document(s) 7 and indicate their approval. The approval may or may not be performed with a signature, depending on the need for a legally-binding approval or just a review checkpoint. The sequence of action items 8 and Access Control List 9 may be customized so that the examination process occurs in the required order.

In one example of the illustrative embodiment of the present invention, a user initiates a type of transaction for which a workflow is defined (or defines one at that time). For example, a contract between party A and party B, with party A being the initating party. Party A initiates the workflow allowing revisions to be made by both parties A and B. As revisions are made, a new version of the document is added to the document history providing an audit trail of modifications. When both parties agree that the contract is suitable, they initiate an electronic signing. This may use any of a number of methods including electronic signature capture and digital signing. They both independently sign the document using the provided interface. At the conclusion the repository contains a document that is considered legally-binding to both signing parties. The signature mechanisms utilize cryptographic technology in order to “fingerprint” or “hash” the contents of the document as well as the signatures in order to allow the document to be validated later on, thereby ensuring that the contents of the document are the same contents signed by the parties without alteration.

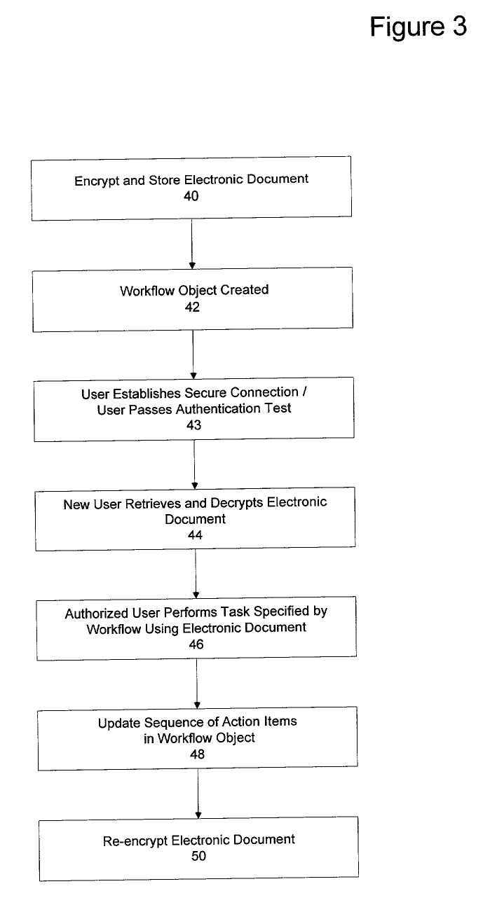

The issue of document security in electronic documents required to execute a workflow is addressed by the illustrative embodiment of the present invention. FIG. 3 is a flow chart of the sequence of steps followed by the illustrative embodiment of the present invention to access a workflow object 6 in order to perform tasks specified in a workflow. The sequence of steps begins when an electronic document 7 is encrypted and stored on the electronic device 4 ( step 40 ). A number of different methods of encrypting and decrypting the electronic document 7 may be used and are discussed in more detail below. A workflow object 6 is created which includes or references the encrypted document 7 ( step 42). The sequence of action items 8 contained in the workflow object 6 represents the steps of the workflow and indicates the current step in the workflow. The sequence of action items 8 indicates which document(s) 7 are next needed in the workflow sequence. A new remotely located user establishes a secure connection to the network storing the workflow objects, such as a Secure Socket Layer connection, and then passes an authentication test ( step 43). For example, the new user may use a login procedure requiring a user ID and password (i.e.: logging in via the PAP or CHAP protocols). Alternatively, the new user may utilize a smart card with encrypted security information or some other sort of authentication procedure as implemented through an extensible interface. Once logged in, the Access Control List 9 indicates which users may access the document(s) 7 to perform the required step. If a new user is authorized to perform the current step in the workflow, the new user is allowed acess to the electronic document(s) 7. After authorization, the new user retrieves and decrypts the electronic document(s) 7( step 44). If the new user is authorized to perform the next step in the workflow sequence, the user performs the workflow requirement ( step 46 ) and the sequence of action items 8 in the workflow object 6 is updated ( step 48). The Access Control List 9 dynamically changes users permissions to reflect the current step in the sequence of action items 8. If the user is not authorized to perform the current step in the workflow sequence, the user is denied access to the document(s) 7 associated with the current step. Once the current step has been performed, the updated electronic document 7 is re-encrypted ( step 50).

The illustrative embodiment employs a variety of techniques to enhance security in workflow using electronic documents. Remotely located users may first be required to log onto the network holding the workflow objects by using a Secure Socket Layers connection. Verification of identity thereafter may be required through the use of existing security login procedures (i.e.: PAP, CHAP protocols which require a User ID and password ) or through the sending of data from a smart card 11. Once a user has access to the network 2 where the workflow objects 6 are stored, the illustrative embodiment of the present invention employs multiple layers of encryption to safeguard workflow. The electronic documents may be signed by a user upon completion of a workflow task by using a digital signature which provides both encryption protection and authentication. The digitally signed object may then be further encrypted. Alternatively, the document(s) 7 included or referenced by the workflow object 6 may be encrypted through the use of an encryption algorithm stored on a user's smart card. As noted above, the entirety of the data stored on the server 20 may be encrypted to restrict access to authorized processes and users.

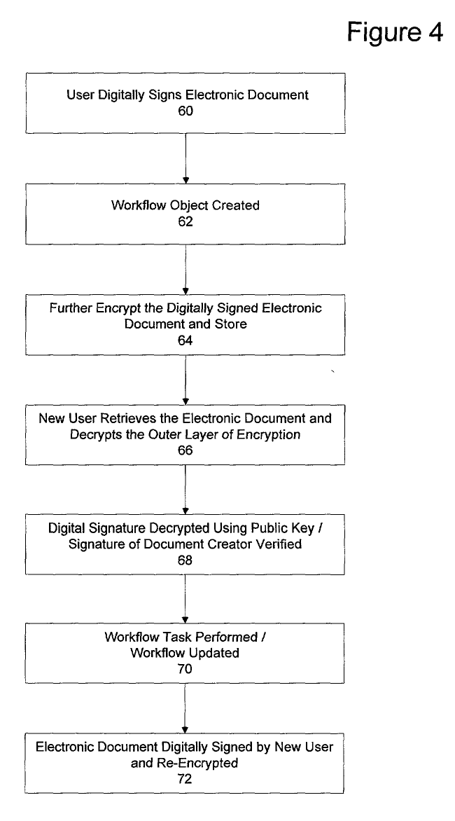

FIG. 4 is a flowchart of the sequence of steps followed by the illustrative embodiment of the present invention in using digital signatures to securely execute workflow. The sequence begins when a user digitally signs an electronic document ( step 60 ). The electronic document is hashed using a hashing algorithm which rearranges the content of the electronic document. The hashed workflow object is then digitally signed with the user's private key to convert the object into a unique numeric value. The private key is an alpha-numeric value which the user's software combines with the hashed document to create a value unique to the particular user ( i.e.: a digital signature). A workflow object 6 is created which includes either the electronic document or a reference to the electronic document as well as a sequence of action items and an Access Control List ( step 62 ). The digitally signed electronic document is then further encrypted and stored on the electronic device ( step 64 ). The further encryption may be directly performed using a separate commercial encryption algorithm, such as the Blowfish 144 bit algorithm, or may occur as a side effect of all data on the server being encrypted. A new user who is required to perform the next step in the workflow accesses the workflow object 6 and decrypts the outer layer of encryption for the electronic document( step 66 ). Those skilled in the art will recognize that the outer layer of encryption may be omitted without departing from the scope of the present invention. Once past the outer layer of encryption, the user encounters the digitally signed electronic document. The user may decrypt the electronic document either by referring to a certificate associated with the electronic document which contains a public decryption key, or alternatively, by utilizing a public key which the user already possesses. Once the electronic document is decrypted, the public key and the same hashing algorithm originally used to created the digital signature are used to rehash the electronic document. The newly hashed result is compared to the hash result that was created by the use of the private key. If a public key hash result and the private key hash result match, the signature of the previous user is verified indicating that the electronic document has not been altered from the time the previous user signed the document ( step 68 ). In other words, the hash of the document is verified against the hash that is bound to the signature ( the signature contains other data, including the document hash). If the two hashes match, the contents of the document have not changed. After the electronic document has been decrypted and the signature verified ( step 68 ), the user performs the task specified in the sequence of action items 8 and the sequence of action items and Access Control List in the workflow object is then updated ( step 70 ). The electronic document is then digitally signed by the new user and optionally further encrypted using the procedures described above ( step 72 ). Those skilled in the art will recognize that the other forms of electronic signature other than digital signatures may also be used. The private key of the new user who accessed the electronic document and performed the workflow task is used to re-encrypt the electronic document. When utilizing asymmetric encryption on a document that will be accessed by multiple users, the document must be decryptable by the private keys of all users who require access. There are algorithms that provide this capability. Decryption may also be automated for any user who has been granted proper access on the ACL, depending on the level of security that is requested.

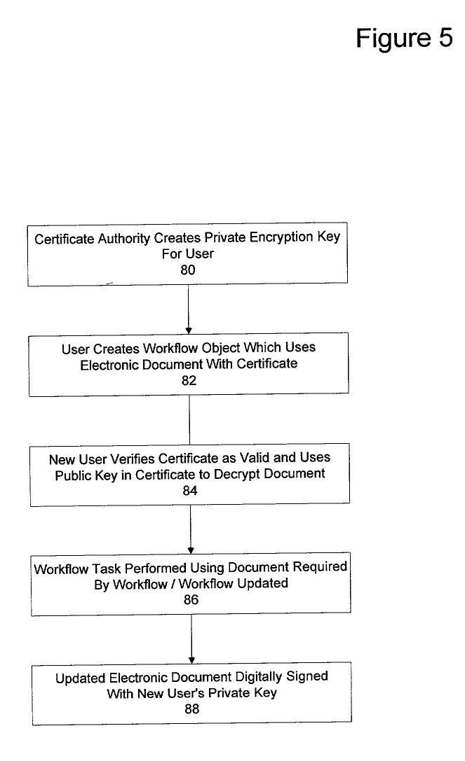

FIG. 5 depicts the sequence of steps followed by the illustrative embodiment of the present invention when the electronic documents 23 used by the workflow include certificates issued by a Certificate Authority 28. The sequence begins when a Certificate Authority 28 creates a private decryption key for a user ( step 80 ). The user creates an electronic document 23 and an associated workflow and digitally signs the electronic document with the private key in the manner outlined above ( step 82 ). The Certificate Authority 28 issues a certificate which includes a public encryption key and binds the public encryption key to the user identity (i.e.: the certificate tells people that the public key is identified with a particular user ). The certificate is linked to the document 23. When a new user wishes to access the document 23 stored on the server, the new user may verify whether the information and the associated certificate are still valid. The certificate is verified by checking with the Certificate Authority 28 which checks a certificate revocation list ( CRL ). If the certificate is verified as valid ( i.e., not revoked ), the public key contained in the certificate is used to decrypt the encrypted electronic document 23 ( step 84 ). Once the document 23 has been decrypted, the document may be verified as authentic by comparing the results of the private key hash with the public key hash as outlined above. After the new user performs a task specified in the workflow, the workflow is updated ( step 86 ). The new user then digitally signs the electronic document 23 with the new user's private key (and optionally further encrypts the electronic document ) ( step 88 ) and then stores the encrypted electronic document back on the server. Those skilled in the art will recognize that multiple types of electronic agents in addition to a certificate authority 28 may be used to generate the key pair, and that the software agents may be located either locally or remotely.

In one embodiment, the server 20 is interfaced with an Entrust™ Server. After an electronic document is stored on the server 20, a remotely located user may view an HTML version by logging onto the server 20 . The server 20 initiates a verification process and receives a verification or rejection from the Entrust™ Server as to whether the document 23 is authentic. After performing a workflow task, the user may digitally sign the electronic document 23 by sending the user's private key information to the server 20 over a Secure Socket Layer 3.0 connection. In one aspect of the embodiment, the user obtains a private key for a digital signature from a separate secure roaming server interfaced with the network. The private key is used by the server to sign a hash of the document 23 to form a digital signature. The digitally signed document may be further hashed and digitally signed. Alternatively, the user may indicate that the document 23 has been reviewed by the user and that the user is not signing the document. The associated workflow is updated to reflect the user's decision.

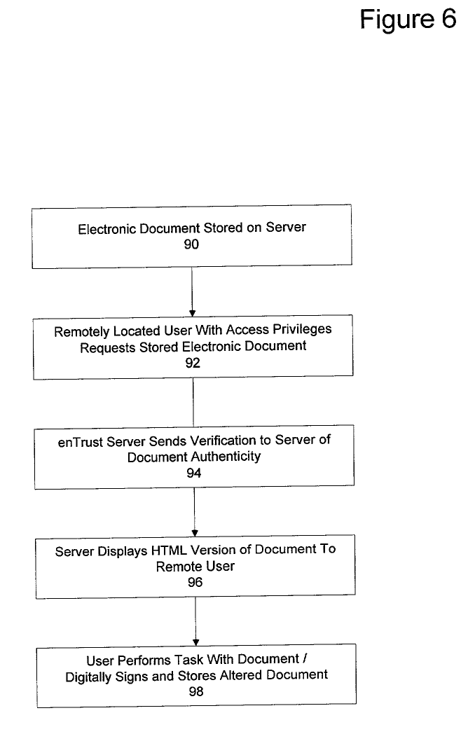

FIG. 6 depicts the sequence of steps used by the illustrative embodiment of the present invention. An electronic document is stored on a server (step 90 ). A remotely located user with access privileges requests the document ( step 92 ). The enTrust™ Server sends verification to the server 20 that the stored document is authentic ( step 94 ). The server displays an HTML version of the document to the requesting user ( step 96 ). After completing a workflow task which alters the document, the user digitally signs the altered document which is then stored on the server ( step 98 ).

It will thus be seen that the invention attains the objectives stated in the previous description. Since certain changes may be made without departing from the scope of the present invention, it is intended that all matter contained in the above description or shown in the accompanying drawings be interpreted as illustrative and not in a literal sense. Practitioners of the art will realize that the sequence of steps depicted in the figures may be altered without departing from the scope of the present invention and that the illustrations contained herein are singular examples of a multitude of possible depictions of the present invention.

We claim:

1. In a network interfaced with an electronic device, a method, comprising the steps of:
providing a document on said electronic device, said document associated with a workflow, said workflow being a sequence of steps required to accomplish a task;
allowing access to said document in response to a request from a remotely located device interfaced with said electronic device via said network, said access being allowed after authenticating the user of said remote electronic device;
updating said workflow to indicate the completion of a task listed in said workflow, said task performed using said document; and
storing said document on said electronic device, said document including an electronic signature from the user of said remote electronic device.

2. The method of claim 1 wherein said electronic signature is a digital signature.

3. The method of claim 1 wherein said user authentication is done over a Secure Socket Layers connection between said remotely located device and said electronic device.

4. The method of claim 1 wherein said document is an encrypted document referenced by a certificate holding encryption data, said certificate associating a public encryption key and a user with a private encryption key.

5. The method of claim 4 wherein said electronic device is interfaced with a Certificate Authority, said Certificate Authority issuing said certificate.

6. The method of claim 5 wherein said Certificate Authority includes a list of invalid certificates.

7. The method of claim 6, comprising the further step of:
validating the certificate associated with said encrypted document by comparing the certificate with said list of invalid certificates prior to decrypting said encrypted document.

8. The method of claim 1 wherein said workflow restricts access to said document to a particular sequence of users.

9. The method of claim 1, comprising the further step of:
indicating that said document has been reviewed by a user pursuant to said workflow and the user is intentionally not signing said document.

10. The method of claim 9 wherein the indication that the user is not signing said document invalidates the document.

11. In a network interfaced with an electronic device, a method, comprising the steps of:
providing a document encrypted using Public Key Infrastructure ( PKI ) on said electronic device, said encrypted document associated with a workflow;
providing a server interfaced with said network, said server interfaced with a certificate authority, said certificate authority issuing certificates binding user identities with public and private encryption keys;
storing at least one encrypted document and an accompanying certificate issued by said certificate authority on said server, said encrypted document associated with a workflow;
decrypting the encrypted document using the information in said certificate in response to a request from a remotely located device interfaced with said network;
updating said workflow to indicate the completion of a task listed in said workflow, said task performed using said document; and
storing said previously encrypted document on said electronic device, said previously encrypted document being re-encrypted prior to being stored.

12. The method of claim 11 comprising the further steps of:
calculating a hash function of the reencrypted document to produce a hashed document; and
storing the hashed document with a digital signature.

13. The method of claim 11, comprising the further steps of:
encrypting said encrypted document using a private encryption key; and
decrypting said encrypted document using a public encryption key.

14. The method of claim 11, comprising the further steps of:
encrypting said encrypted document using a public encryption key; and
decrypting said encrypted document using a private encryption key.

15. The method of claim 11 wherein said workflow associated with said encrypted document restricts access to said document to a specific sequence of users.

16. The method of claim 11, comprising the further step of:
indicating that the encrypted document has been reviewed pursuant to said workflow by a user and that the user is intentionally not signing said encrypted document.

17. The method of claim 16 wherein the indication that the user is not signing the encrypted document invalidates the document.

18. In a network interfaced with an electronic device, a method, comprising the steps of:
providing an encrypted document on said electronic device, said encrypted document associated with a workflow; said workflow being a sequence of steps required to accomplish a task;
decrypting said encrypted document in response to a request from a remotely located device interfaced with said electronic device via said network;
performing a task with said document indicated by said workflow; and
updating said workflow to indicate the completion of a task listed in said workflow, said task performed using said document.

19. In a network interfaced with an electronic device, a method, comprising the steps of:
providing an encrypted document on said electronic device, said encrypted document associated with a workflow, said workflow being a sequence of steps required to accomplish a task;
decrypting said encrypted document in response to a request from a remotely located device interfaced with said electronic device via said network;
updating said workflow to indicate the completion of a task listed in said workflow, said task performed using said document; and
storing said previously encrypted document on said electronic device, said previously encrypted document being re-encrypted prior to being stored.

20. The method of claim 19 comprising the further steps of:
calculating a hash function of the reencrypted document to produce a hashed document; and
storing the hashed document with a digital signature.

21. The method of claim 19 wherein said decrypting is done over a Secure Socket Layers connection between said remotely located device and said electronic device.

22. The method of claim 19 wherein said encrypted document references a certificate holding encryption data, said certificate associating a public encryption key and a user with a private encryption key.

23. The method of claim 22 wherein said electronic device is interfaced with a Certificate Authority, said Certificate Authority issuing said certificate.

24. The method of claim 23 wherein said Certificate Authority includes a list of invalid certificates.

25. The method of claim 24, comprising the further step of:
validating the certificate associated with said encrypted document by comparing the certificate with said list of invalid certificates prior to decrypting said encrypted document.

26. The method of claim 19 wherein said workflow restricts access to said encrypted document to a particular sequence of users.

27. The method of claim 19, comprising the further step of:
indicating that the encrypted document has been reviewed by a user pursuant to said workflow and the user is intentionally not signing said encrypted document.

28. The method of claim 27 wherein the indication that the user is not signing the encrypted document invalidates the document.

29. In a network with an electronic device, said electronic device holding at least one encrypted document associated with a workflow, a medium holding computer-executable steps for a method, said method comprising the steps of:
decrypting said encrypted document in response to a request from a remotely located device interfaced with said network over a secure connection;
updating said workflow to indicate the completion of a task listed in said workflow, said task performed using said document; and
storing said previously encrypted document, said previously encrypted document being re-encrypted prior to being stored.

30. The medium of claim 29 wherein said workflow associated with said encrypted document restricts access to said document to a specific sequence of users.

31. The medium of claim 30 wherein said method, comprises the further step of:
indicating that the encrypted document has been reviewed pursuant to said workflow by a user and that the user is intentionally not signing said encrypted document.
